(19) United States
(12) Patent Application Publication
(10) Pub. No.: US 2026/0366859 A1
(43) Pub. Date: Nov. 19, 2026

(54) MEASUREMENT SYSTEM, MEASUREMENT APPARATUS, IMAGING APPARATUS, AND MEASUREMENT METHOD

(71) Applicant: MITUTOYO CORPORATION, Kanagawa (JP)

(72) Inventor: Jiro ISHIKAWA, Kanagawa (JP)

(73) Assignee: MITUTOYO CORPORATION, Kanagawa (JP)

(21) Appl. No.: 19/641,162

(22) Filed: Apr. 7, 2026

(30) Foreign Application Priority Data
May 16, 2025 (JP) 2025-082441

(51) Int. Cl. G01B 11/00

(52) U.S. Cl. CPC G01B 11/005

(57) ABSTRACT

A measurement system includes: an imaging part configured to, while being mounted on a mounting portion, generate captured image data by capturing an image of a workpiece at a basic capture timing synchronized with a first synchronization signal, transmit the first synchronization signal on a first wireless channel, and transmit the captured image data on a second wireless channel different from the first wireless channel; a first communication part that receives the first synchronization signal from the imaging part via the first wireless channel and transmits the second synchronization signal to the machine apparatus on the basis of the first synchronization signal; and a data processing part that associates position coordinate data indicating a position of the imaging part with the captured image data generated at the basic capture timing, the position coordinate data being output from the machine apparatus that has received the second synchronization signal.

### CROSS-REFERENCE TO RELATED APPLICATIONS

The present application claims priority to Japanese Patent Application number 2025-082441, filed on May 16, 2025, contents of which are incorporated herein by reference in their entirety.

### BACKGROUND

The present disclosure relates to a measurement system, a measurement apparatus, an imaging apparatus, and a measurement method for measuring a workpiece which is an object to be measured.

Conventionally, an apparatus is known in which a sensor is mounted in a tool accommodating portion of a machine tool and measurement results of a workpiece obtained by the sensor are output.

### SUMMARY

According to one aspect, a measurement system for measuring a workpiece mounted on a machine apparatus having a function of controlling a position of a mounting portion to which a device for processing or measuring the workpiece is detachably mounted, the measuring system including: an imaging part configured to, while being mounted on the mounting portion, generate captured image data by capturing an image of the workpiece at a basic capture timing synchronized with a first synchronization signal, transmit the first synchronization signal on a first wireless channel, and transmit the captured image data on a second wireless channel different from the first wireless channel; a communication part that receives the first synchronization signal from the imaging part via the first wireless channel and transmits a second synchronization signal to the machine apparatus on the basis of the first synchronization signal; and a data processing part that associates position coordinate data indicating a position of the imaging part with the captured image data generated at the basic capture timing, the position coordinate data being output from the machine apparatus that has received the second synchronization signal.

### BRIEF DESCRIPTION OF THE DRAWINGS

FIG. 1 is a diagram for explaining an overview of a measurement system S.

FIG. 2 is a diagram illustrating a first timing example of a plurality of signals used for measurement in the measurement system S.

FIG. 3 is a diagram illustrating a second timing example of a plurality of signals used for measurement in the measurement system S.

FIG. 4 is a diagram illustrating a third timing example of a plurality of signals used for measurement in the measurement system S.

FIG. 5 is a diagram illustrating a fourth timing example of a plurality of signals used for measurement in the measurement system S.

FIG. 6 is a diagram illustrating a configuration of a machine apparatus 1A according to a modification.

FIG. 7 is a diagram illustrating a configuration of a measurement system S according to a fourth modification.

### DETAILED DESCRIPTION

### Overview of a Measurement System S

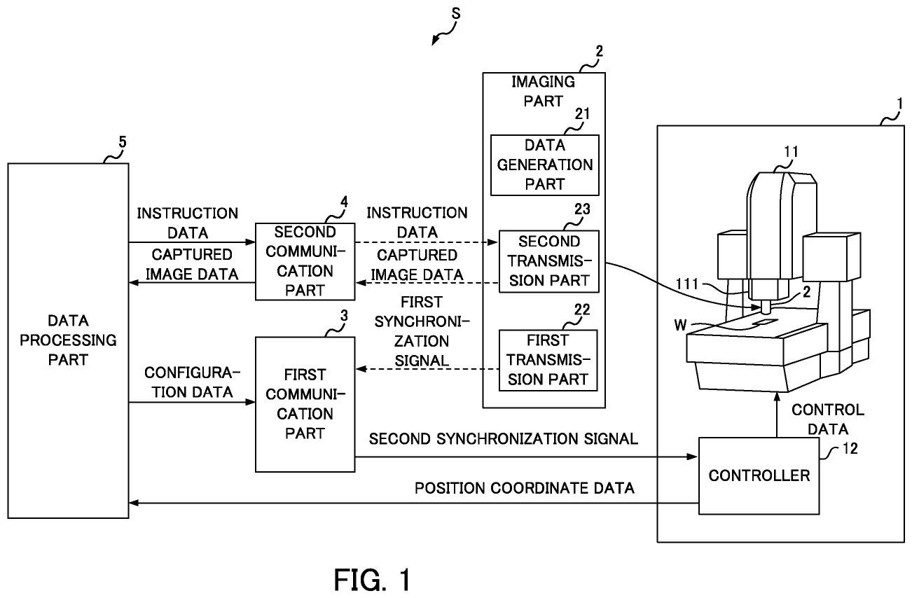

FIG. 1 is a diagram for explaining an overview of a measurement system S. The measurement system S includes a machine apparatus 1, an imaging part 2, a first communication part 3, a second communication part 4, and a data processing part 5. The machine apparatus 1 includes a main body 11 and a controller 12. The main body 11 includes a mounting portion 111. The measurement system S is a system for measuring a workpiece W, which is a measurement target object placed on the main body 11, by using the imaging part 2 mounted on the mounting portion 111.

The main body 11 has a function of controlling a position of the mounting portion 111 to which a device for processing or measuring the workpiece W is detachably mounted, and is, for example, a machine tool apparatus or a coordinate measuring machine. The mounting portion 111 is, for example, a tool holder configured to allow replacement and mounting of a cutting tool for processing the workpiece W, a measuring probe, an imaging sensor, or the like for measuring the shape of the workpiece W. The mounting portion 111 is movable in a plurality of directions. The mounting portion 111 is configured to be movable in, for example, three directions (an X direction, a Y direction, and a Z direction) orthogonal to each other, but may be movable in two directions in a horizontal plane. The mounting portion 111 may be configured to be movable by an arm having four or more axes.

The controller 12 is a computer for controlling the main body 11. The controller 12 causes a display to display an operation screen for a user of the main body 11 to select an operation mode, and transmits control data to the main body 11 to cause the main body 11 to operate in the selected operation mode.

Specifically, the controller 12 moves a device corresponding to the operation mode by transmitting control data for replacing the device mounted on the mounting portion 111 to the main body 11 or transmitting control data for moving the position of the mounting portion 111 to the main body 11. The controller 12 may transmit the control data received from the data processing part 5 to the main body 11. The controller 12 may continuously cause the mounting portion 111 to move during the measurement period, or may alternately cause the mounting portion 111 to move and stop. In response to an input of a predetermined signal from outside, the controller 12 outputs position coordinate data indicating the position of the mounting portion 111 in the coordinate system of the main body 11. In the present embodiment, the controller 12 outputs position coordinate data to the data processing part 5 in response to an input of a second synchronization signal from the first communication part 3 described later.

The imaging part 2 generates captured image data by capturing an image of the workpiece W. The captured image data may be data indicating a position of a group of points indicating feature points of the workpiece W, or may be data in which coordinates of pixels and pixel values are associated with each other. As one example, the imaging part 2 captures an image of the workpiece W at predetermined intervals. The captured image data generated by one capturing includes, for example, a frame number, the number of feature points included in the captured image data, and point cloud data indicating the positions of the feature points.

The imaging part 2 includes a data generation part 21, a first transmission part 22, and a second transmission part 23. While the imaging part 2 is mounted on the mounting portion 111, the data generation part 21 generates a reference signal used to determine a timing of capturing the workpiece W, and generates captured image data by capturing an image of the workpiece W at a basic capture timing synchronized with the reference signal. The reference signal is, for example, a rectangular wave signal generated at a constant period. The period of the reference signal is, for example, the same as the period in which the controller 12 can output the position coordinate data. The period of the reference signal may be set by the user via the data processing part 5. The data generation part 21 inputs the generated reference signal to the first transmission part 22, and inputs the captured image data to the second transmission part 23. The imaging part 2 may include a memory, and the data generation part 21 may temporarily store the captured image data in the memory.

The data generation part 21 sets, as a capture timing, a timing delayed from the reference signal by a predetermined time such that the timing at which the controller 12 outputs the position coordinate data coincides with the capture timing. Although details will be described later, the predetermined time is a time required from when the reference signal is input to the first transmission part 22 to when a synchronization signal (a “second synchronization signal” described later) based on the reference signal is input to the controller 12 and the position coordinate data is output from the controller 12 on the basis of the synchronization signal.

In response to power being supplied to the imaging part 2, the data generation part 21 starts generating the reference signal at a set period. After starting the generation of the reference signal, the data generation part 21 starts generating the captured image data. For example, the data generation part 21 transmits an operation start instruction to the first communication part 3 via the first transmission part 22, and starts generating the captured image data in response to receiving a reply from the first communication part 3.

In response to receiving a notification from the first communication part 3 that synchronization has been established upon reception of a first synchronization signal transmitted by the first transmission part 22, which will be described later, the data generation part 21 may start the generation of the captured image data after providing a notification to the first communication part 3 that image capturing is to be started. When the notification that synchronization has been established cannot be received within a predetermined time from the start of generation of the reference signal, the data generation part 21 may provide, via the second communication part 4, a notification to the data processing part 5 that an error has occurred. This prevents the generation of the captured image data from being started in a state in which the imaging part 2 and the first communication part 3 are not synchronized with each other.

The data generation part 21 ends the generation of the captured image data in response to receiving an instruction to end capturing from the data processing part 5. For example, the data generation part 21 transmits an operation end instruction to the first communication part 3 via the first transmission part 22, and ends the generation of captured image data in response to receiving a reply from the first communication part 3. The data generation part 21 may monitor the voltage value of a battery of the imaging part 2 and end the generation of the captured image data when the remaining amount of the battery becomes equal to or less than a threshold.

The first transmission part 22 is a synchronization signal transmission part that generates a first synchronization signal synchronized with the reference signal input from the data generation part 21 and transmits the first synchronization signal on a first wireless channel. As one example, the first transmission part 22 generates data including a header and error correction data at a timing synchronized with the reference signal input from the data generation part 21, and generates the first synchronization signal by modulating (for example, via FSK modulation) the generated data. The first synchronization signal transmitted on the first wireless channel is composed of, for example, a signal in which 256-bit data is modulated. The header may include a serial number indicating the order of the captured image data generated after the imaging part 2 starts capturing the workpiece W

The second transmission part 23 is an image data transmission part that transmits captured image data on a second wireless channel different from the first wireless channel. The second transmission part 23 adds the header and the error correction data to the captured image data input from the data generation part 21 and transmits the captured image data on the second wireless channel by modulating these sets of data. In order to transmit the captured image data having a larger data amount than the first synchronization signal, the second wireless channel is a wireless channel having a transmission rate of, for example, about 20 Mbps to 150 Mbps. The second wireless channel is, for example, a wireless channel based on a standardized communication system such as Wi-Fi (registered trademark).

The first wireless channel is, for example, a wireless channel in which communication is performed using a low-delay protocol having a transmission delay time shorter than the transmission delay time (for example, 100 milliseconds) of the second wireless channel. The transmission delay time of the first wireless channel is, for example, 10 milliseconds or less. The first wireless channel may be a wireless channel having a transmission rate lower than that of the second wireless channel. In order to avoid radio wave interference between the first wireless channel and the second wireless channel, the frequency band of the first wireless channel (for example, 2.4 GHz band) may be different from the frequency band of the second wireless channel (for example, 5 GHz band).

The first communication part 3 is a communication device that receives the first synchronization signal from the imaging part 2 via the first wireless channel and transmits the second synchronization signal to the machine apparatus 1 on the basis of the first synchronization signal. Specifically, the first communication part 3 demodulates data including the modulated first synchronization signal, and generates a rectangular wave second synchronization signal on the basis of the demodulated first synchronization signal. The second synchronization signal may include data indicating a serial number representing the order of the second synchronization signals generated after the first communication part 3 initially receives the first synchronization signal.

The first communication part 3 transmits the second synchronization signal to the machine apparatus 1 via a general-purpose communication interface such as a digital I/O. The first communication part 3 may have any form, and the second synchronization signal may be transmitted via another communication interface such as USB (Universal Serial Bus), SPI, or I2C. By having the second synchronization signal input to the controller 12, the controller 12 outputs position coordinate data indicating the position of the mounting portion 111 at the time when the second synchronization signal is input. The position coordinate data may include a serial number indicating the order of position coordinate data output after the controller 12 initially receives the second synchronization signal.

The second communication part 4 is a communication device having a function of transmitting and receiving data between the imaging part 2 and the data processing part 5, and is, for example, a router. Upon receiving instruction data for starting measurement from the data processing part 5, the second communication part 4 transmits the instruction data to the imaging part 2. Upon receiving the captured image data from the second transmission part 23 via the second wireless channel, the second communication part 4 transmits the captured image data to the data processing part 5. When the first wireless channel is a general-purpose wireless channel such as Wi-Fi, the second communication part 4 does not need to be a communication device dedicated to the measurement system S, and may be a general-purpose router.

By executing a program stored in the memory, the data processing part 5 measures the workpiece W by associating (i) position coordinate data indicating the position of the imaging part 2, the position coordinate data being output from the machine apparatus 1 that has received the second synchronization signal, with (ii) the captured image data generated at the basic capture timing. The data processing part 5 is connected to the second communication part 4 and the controller 12 via a network (for example, a LAN), and receives, on a periodic basis, captured image data output by the imaging part 2 via the second communication part 4 by transmitting the instruction data to the second communication part 4. In addition, the data processing part 5 receives the position coordinate data output from the controller 12.

The data processing part 5 identifies the position of the feature point included in the captured image data in the coordinate system of the main body 11 on the basis of the position indicated by the position coordinate data associated with the captured image data. For example, the data processing part 5 measures the distances between the plurality of feature points on the basis of the positions of the plurality of feature points. In this case, the data processing part 5 may determine the quality of the workpiece W by comparing the measured distance with a reference value. The data processing part 5 may measure the shape of the workpiece W on the basis of the positions of the plurality of feature points.

The data processing part 5 measures the workpiece W in the following flow, for example. The data processing part 5 causes the imaging part 2 to generate captured image data while the imaging part 2 is mounted on the mounting portion 111. Subsequently, the data processing part 5 causes the first communication part 3 to receive the first synchronization signal from the imaging part 2 via the first wireless channel, and causes the first communication part 3 to transmit the second synchronization signal to the machine apparatus 1 on the basis of the first synchronization signal. Then, the data processing part 5 receives the captured image data from the second communication part 4 that receives the captured image data from the imaging part 2 via the second wireless channel. The data processing part 5 measures the workpiece W by associating (i) the position coordinate data indicating the position of the imaging part 2 output from the machine apparatus 1 that has received the second synchronization signal with (ii) the captured image data generated at the basic capture timing.

The data processing part 5 identifies captured image data corresponding to the position coordinate data from among a plurality of pieces of received captured image data. The data processing part 5 measures the workpiece W by associating each of a plurality of pieces of captured image data acquired after transmitting an instruction to the imaging part 2 to start capturing the workpiece W with position coordinate data acquired in the same order as the order in which the pieces of captured image data are acquired. In other words, the data processing part 5 manages an order of a plurality of pieces of captured image data received after the instruction data for starting the measurement is transmitted and an order of a plurality of pieces of position coordinate data received after the instruction data for starting the measurement is transmitted, and associates pieces of captured image data and pieces of position coordinate data having the same order with each other.

Specifically, the data processing part 5 stores each of a plurality of pieces of captured image data at first addresses corresponding to a captured-image-data storage area in the memory in the order in which the plurality of pieces of captured image data are captured. Furthermore, each time the position coordinate data is received sequentially from the machine apparatus 1, the data processing part 5 stores position coordinate data at second addresses corresponding to a position-coordinate-data storage area in the memory. As described above, by storing the plurality of pieces of captured image data and the plurality of pieces of position coordinate data at the addresses corresponding to the order in which the plurality of pieces of captured image data and the plurality of pieces of position coordinate data are acquired, the data processing part 5 can associate the position coordinate data indicating the position of the imaging part 2 output from the machine apparatus 1 that has received the second synchronization signal with the captured image data generated at the basic capture timing.

After transmitting the instruction to start capturing the workpiece W to the imaging part 2, the data processing part 5 may measure the workpiece W by associating position coordinate data acquired within a predetermined time range with captured image data. The predetermined time range is, for example, the maximum value of the time difference between (i) a timing at which the captured image data generated by the imaging part 2 on the basis of the reference signal reaches the data processing part 5 and (ii) a timing at which the position coordinate data output by the controller 12 to which the second synchronization signal based on the reference signal is input reaches the data processing part 5.

### Timing Relationship of a Plurality of Signals

### First Timing Example

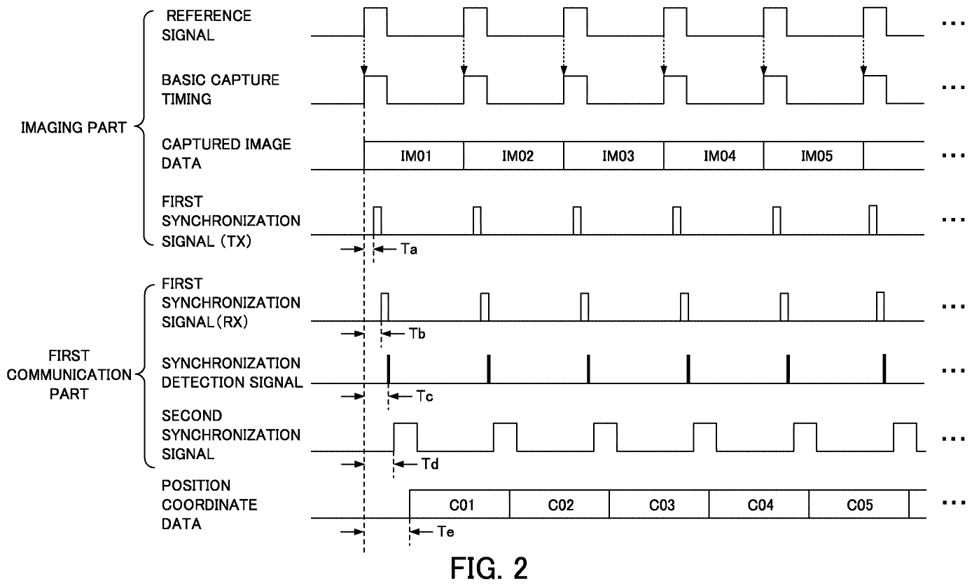

FIG. 2 is a diagram illustrating a first timing example of a plurality of signals used for measurement in the measurement system S. In the example shown in FIG. 2, the rising timing of the reference signal generated by the data generation part 21 corresponds to the basic capture timing. That is, the pieces of captured image data (IM01, IM02, . . .) are output at the rising timing of the reference signal. The first synchronization signal is transmitted from the imaging part 2 to the first communication part 3 at a timing delayed from the reference signal by Ta.

The first communication part 3 receives the first synchronization signal transmitted on the first wireless channel. The timing at which the first communication part 3 receives the first synchronization signal is delayed from the timing at which the imaging part 2 transmits the first synchronization signal by a wireless transmission time, and the timing at which the first communication part 3 receives the first synchronization signal is delayed from the reference signal by Tb.

The first communication part 3 generates a synchronization detection signal by demodulating the received first synchronization signal. For example, the first communication part 3 generates the synchronization detection signal on the basis of the timing at which a data sequence of the predetermined pattern included in the demodulated first synchronization signal is detected. The timing at which the first communication part 3 generates the synchronization detection signal is delayed from the timing at which the first synchronization signal is received by the time required for a synchronization detection process, and is delayed from the reference signal by Tc.

The first communication part 3 generates the second synchronization signal in response to the generation of the synchronization detection signal, and outputs the generated second synchronization signal. The timing at which the first communication part 3 outputs the second synchronization signal is delayed from the reference signal by Td.

The controller 12 that has received the second synchronization signal outputs the position coordinate data (C01, C02, . . .) at a timing synchronized with the second synchronization signal. The timing at which the position coordinate data is output corresponds to a timing delayed from the reference signal by Te.

The data processing part 5 associates the captured image data IM01 with the position coordinate data C01, and associates the captured image data IM02 with the position coordinate data C02. When a delay time of the first wireless channel through which the first synchronization signal is transmitted is sufficiently small to obtain a required measurement accuracy, the position coordinate data associated with the captured image data can be considered to indicate the position of the imaging part 2 at a time point at which the captured image data is captured. Therefore, the data processing part 5 can measure the workpiece W on the basis of the associated captured image data and position coordinate data.

### Second Timing Example

When a moving speed of the mounting portion 111 is high, it is conceivable that the measurement accuracy decreases due to the delay time of the first wireless channel. Therefore, by delaying the basic capture timing relative to the reference signal, the imaging part 2 may allow the position coordinate data associated with the captured image data to indicate the position of the imaging part 2 at a time point at which the captured image data is captured.

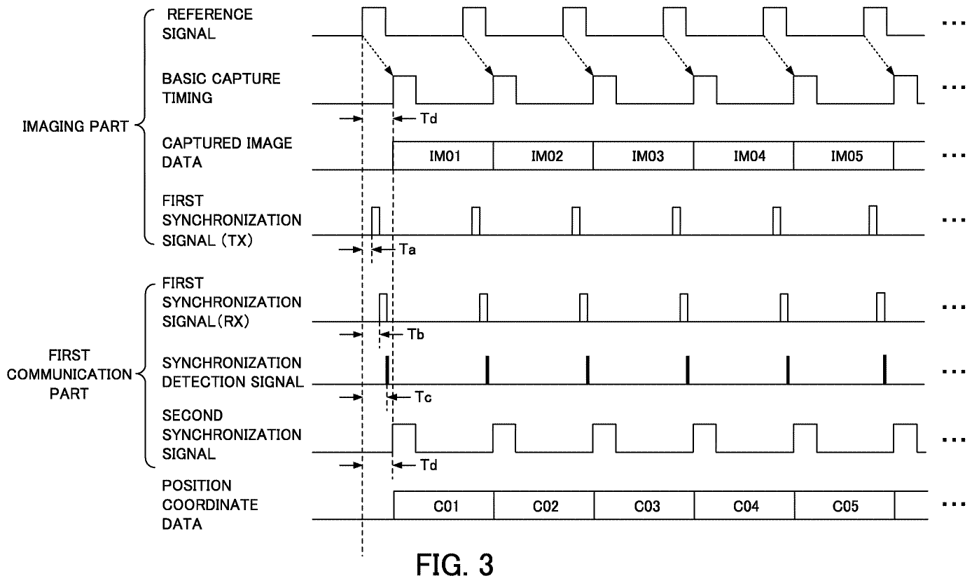

FIG. 3 is a diagram illustrating a second timing example of a plurality of signals used for measurement in the measurement system S. The basic capture timing in the example illustrated in FIG. 3 is a timing delayed from the timing at which the first synchronization signal is generated by a delay time (Td-Ta) from when the first synchronization signal is generated to when the first communication part 3 transmits the second synchronization signal. The basic capture timing may be a timing delayed from the timing at which the first synchronization signal is generated by a delay time from when the first synchronization signal is generated to when the data processing part 5 receives the position coordinate data.

By the imaging part 2 setting, as the basic capture timing, a timing that is substantially the same as the timing at which the first communication part 3 transmits the second synchronization signal or the timing at which the data processing part 5 receives the position coordinate data, the position indicated by the position coordinate data becomes equal to the position of the mounting portion 111 at a time point at which the captured image data is generated, thereby further improving the measurement accuracy.

### Third Timing Example

Since the first synchronization signal is transmitted on the first wireless channel, it is conceivable that the first synchronization signal may not reach the first communication part 3 when the radio wave environment deteriorates. Therefore, after determining whether or not the first synchronization signal has been normally received, the first communication part 3 may generate the second synchronization signal on the basis of the determination result. For example, when it is determined that the first synchronization signal has been normally received, the first communication part 3 generates the second synchronization signal on the basis of the first synchronization signal, and when it is determined that the first synchronization signal has not been normally received, the first communication part 3 generates a dummy second synchronization signal without relying on the first synchronization signal.

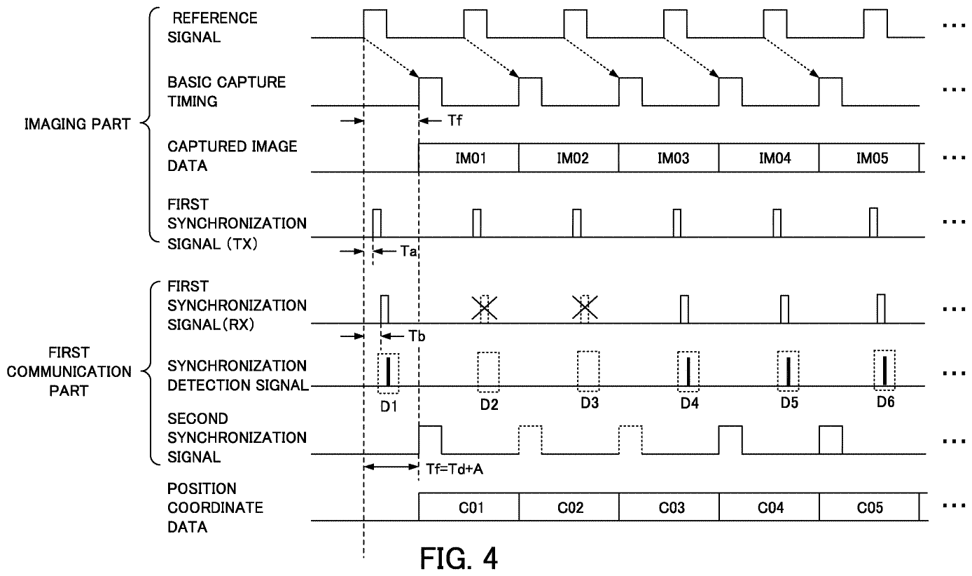

FIG. 4 is a diagram illustrating a third timing example of a plurality of signals used for measurement in the measurement system S. In the example illustrated in FIG. 4, the first communication part 3 predicts, on the basis of timings at which the first synchronization signal has been received in the past, a period (periods D1 to D6 indicated by dotted lines in FIG. 4) during which the next first synchronization signal is likely to be received, and determines whether or not the first synchronization signal has been normally received within the predicted period. When the first synchronization signal is not detected in this period, the first communication part 3 determines that the first synchronization signal is not normally received.

In the example illustrated in FIG. 4, the first synchronization signal is not detected in the periods D2 and D3. In such a case, the first communication part 3 generates a dummy second synchronization signal indicated by a broken line.

In order to secure the time for determining whether or not the first synchronization signal is normally received, the first communication part 3 may generate a second synchronization signal corresponding to the first synchronization signal at a timing obtained by delaying the received first synchronization signal, on the basis of an offset time required for determining whether or not the first synchronization signal has been normally received. When the offset time is A, a delay time Tf from the timing of the reference signal to the timing at which the first communication part 3 transmits the second synchronization signal is Td+A, obtained by adding the offset time A to the delay time Td illustrated in FIG. 2. The imaging part 2 sets the delay time of the basic capture timing relative to the reference signal to Tf, whereby, also in this case, the position indicated by the position coordinate data coincides with the position of the mounting portion 111 at a time point at which the captured image data is captured.

When it is determined that the first synchronization signal was not normally received, the first communication part 3 generates the second synchronization signal at a timing at which a time corresponding to the period of the first synchronization signal has elapsed since the second synchronization signal was previously generated. Specifically, the first communication part 3 activates a timer every time the first synchronization signal is received, and generates a dummy second synchronization signal when the value of the timer reaches a value set in advance as the period of the first synchronization signal. By having the first communication part 3 operate in this manner, the second synchronization signal is generated even if the first synchronization signal is lost during transmission on the first wireless channel, and thus the data processing part 5 can acquire the position coordinate data corresponding to the captured image data.

It should be noted that the first communication part 3 may have a function of transmitting data to the imaging part 2 or the data processing part 5, and when the first synchronization signal was not normally received, may provide data indicating that the first synchronization signal was not normally received to the imaging part 2 or the data processing part 5. Accordingly, a warning indicating that a transmission state of the first synchronization signal is poor is displayed by the imaging part 2 or the data processing part 5, thereby enabling the user to inspect or replace the imaging part 2.

In addition, the imaging part 2 and the first communication part 3 may be operated by an oscillator having high frequency accuracy such that a period of the dummy second synchronization signal generated by the timer is substantially equal to the period of the first synchronization signal generated by the imaging part 2. The imaging part 2 and the first communication part 3 include, for example, a temperature-compensated crystal oscillator (TCXO), and generate a synchronization signal on the basis of an oscillation signal generated by the temperature-compensated crystal oscillator. Accordingly, even if the first communication part 3 cannot temporarily receive the first synchronization signal, the second synchronization signal can be generated at substantially the same timing as when the first synchronization signal is received.

Even when the imaging part 2 and the first communication part 3 operate using the oscillator with high frequency accuracy as described above, if the first communication part 3 continues to fail to normally receive the first synchronization signal, a deviation between the first synchronization signal and the second synchronization signal increases. Therefore, the first communication part 3 may notify the imaging part 2 or the data processing part 5 that an error has occurred when the number of times that the first synchronization signal was not normally received exceeds a preset number of times.

In addition, the first communication part 3 may include a phase-locked-loop (PLL) that generates an oscillation signal on the basis of the first synchronization signal. By having the first communication part 3 generate the second synchronization signal on the basis of the oscillation signal generated by the PLL, the first communication part 3 can generate a second synchronization signal on the basis of the oscillation signal having the same frequency as the oscillation signal generated internally by the imaging part 2. Accordingly, also in this case, even if the first communication part 3 cannot temporarily receive the first synchronization signal, the second synchronization signal can be generated at substantially the same timing as when the first synchronization signal is received.

### Fourth Timing Example

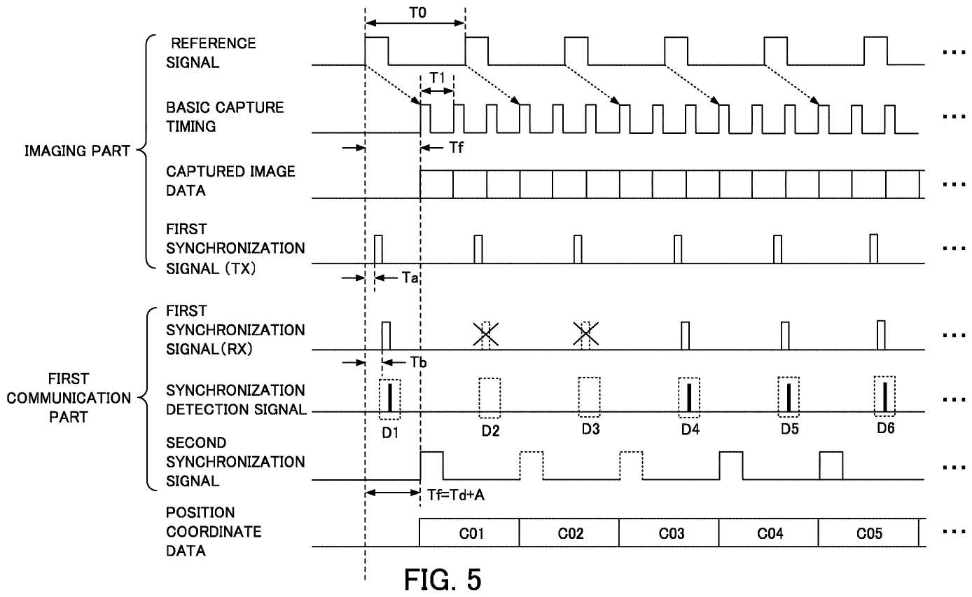

FIG. 5 is a diagram illustrating a fourth timing example of a plurality of signals used for measurement in the measurement system S. The example illustrated in FIG. 5 is different from the other examples described above in that the imaging part 2 generates the captured image data at one or more predetermined capture timings located between a plurality of basic capture timings that occur with the same period as the reference signal.

When the period of the reference signal is T0 and the time interval of the capture timing shown in FIG. 5 is T1, T0 is, for example, the integral multiple of T1. It should be noted that T0 does not need to be the integral multiple of T1, and the relationship between T0 and T1 may be a relationship satisfying the condition “T0×m=T1×n, m<n, and m and n are integers”. Further, the relationship between T0 and T1 may be a relationship satisfying the condition “T0×m=T1×n, m<n, and m and n are decimal numbers”.

In this example, the data processing part 5 may estimate one or more coordinates of a position of the imaging part 2 at one or more capture timings located between the plurality of basic capture timings, on the basis of a plurality of coordinates indicated by the plurality of pieces of position coordinate data corresponding to the plurality of pieces of basic capture timings. The data processing part 5 measures the workpiece W on the basis of one or more pieces of captured image data corresponding to one or more capture timings and one or more estimated coordinates.

As an example, when the mounting portion 111 moves at a constant speed and a relationship of T0=T1×n is satisfied, the data processing part 5 can estimate the position of the imaging part 2 at one or more capture timings between the plurality of basic capture timings by dividing, into n equal parts, a straight line that connects a plurality of coordinates indicated by a plurality of pieces of position coordinate data corresponding to a plurality of basic capture timings, and calculating the coordinates of the starting point of each divided straight line.

By having the imaging part 2 and the data processing part 5 operate in this manner, the workpiece W can be measured using the captured image data generated at a time interval smaller than the time interval at which the controller 12 can output the position coordinate data, thereby further improving the measurement accuracy.

### First Modification

In the above description, the first communication part 3, the second communication part 4, and the data processing part 5 are not included in the machine apparatus 1, but at least a part of the first communication part 3, the second communication part 4, and the data processing part 5 may be included in the machine apparatus 1.

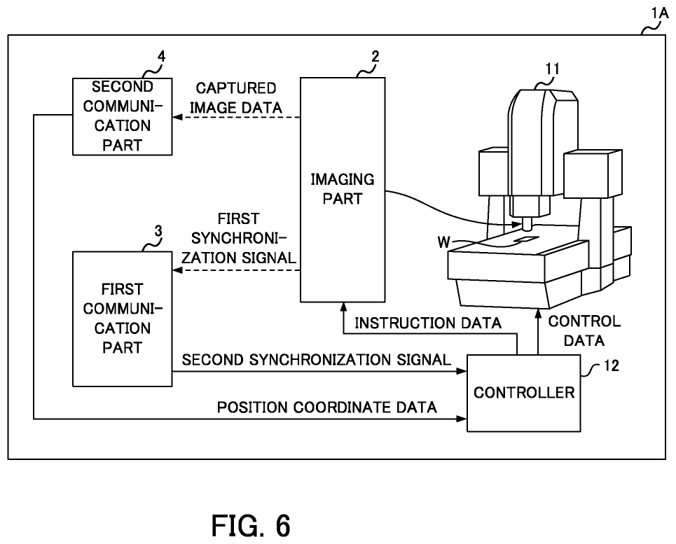

FIG. 6 is a diagram illustrating a configuration of a machine apparatus 1A according to a modification. The machine apparatus 1A may be a machine tool apparatus or a coordinate measuring machine. In FIG. 6, portions denoted by the same reference numerals as those in FIG. 1 have the same functions as those in the machine apparatus 1, but a controller 12 shown in FIG. 6 also has the function of the data processing part 5 in FIG. 1. The controller 12 controls the main body 11, transmits instruction data for starting measurement to the imaging part 2, and receives captured image data via the second communication part 4.

The controller 12 measures the workpiece W by associating the captured image data received from the imaging part 2 with the position coordinate data indicating the position of the imaging part 2 at the timing at which the second synchronization signal is received from the first communication part 3. With this configuration of the machine apparatus 1A, it is not necessary to provide a computer for controlling the main body 11 and a computer for measuring the workpiece W, and therefore the configuration is advantageous in terms of installation area and cost.

### Second Modification

In the above description, a case has been described in which the same number of first synchronization signals as the number of second synchronization signals transmitted to the machine apparatus 1 by the first communication part 3 are transmitted from the imaging part 2 to the first communication part 3, but the number of generations of the first synchronization signals may be smaller than the number of generations of the second synchronization signals. As one example, the imaging part 2 transmits one first synchronization signal at a start of measurement and transmits one first synchronization signal at an end of the measurement.

After transmitting the first synchronization signal at the start of the measurement, the imaging part 2 captures the workpiece W at a basic capture timing equal to a predetermined period of the first synchronization signal. After initially receiving the first synchronization signal, the first communication part 3 generates a second synchronization signal at a predetermined period of the second synchronization signal. When a difference between an operating frequency of the imaging part 2 and an operating frequency of the first communication part 3 is sufficiently small relative to a measurement time, a deviation between the basic capture timing and the timing of the second synchronization signal can be suppressed. With this configuration, the data processing part 5 can measure the workpiece W while reducing the power required for the imaging part 2 to transmit the first synchronization signal.

### Third Modification

In the above description, the imaging part 2 transmits the first synchronization signal for the purpose of allowing the first communication part 3 to generate the second synchronization signal for acquiring the position coordinate data from the controller 12, but the imaging part 2 may use the first synchronization signal for other purposes. As one example, the imaging part 2 may include a sensor that detects a nearby object, and may generate a first synchronization signal including flag data indicating that an object is present in the vicinity when the nearby object is detected.

In this case, the first communication part 3 transmits, to the controller 12, flag data indicating that an object is present in the vicinity. When the flag data is received, the controller 12 stops the movement of the mounting portion 111. Although the first communication part 3 transmits the flag data via a communication interface (for example, a digital I/O) different from the communication interface over which the second synchronization signal is transmitted, the first communication part 3 may also transmit the second synchronization signal including the flag data. With the measurement system S configured in this manner, it is possible to prevent, for example, a case in which the imaging part 2 mounted on the mounting portion 111 collides with an obstacle due to an inappropriate control program in the controller 12, causing failure of the imaging part 2 or damage to the workpiece W.

### Fourth Modification

Although the imaging part 2 generates the first synchronization signal in the above description, the first communication part 3 may generate the first synchronization signal and transmit the generated first synchronization signal to the imaging part 2 on the first wireless channel.

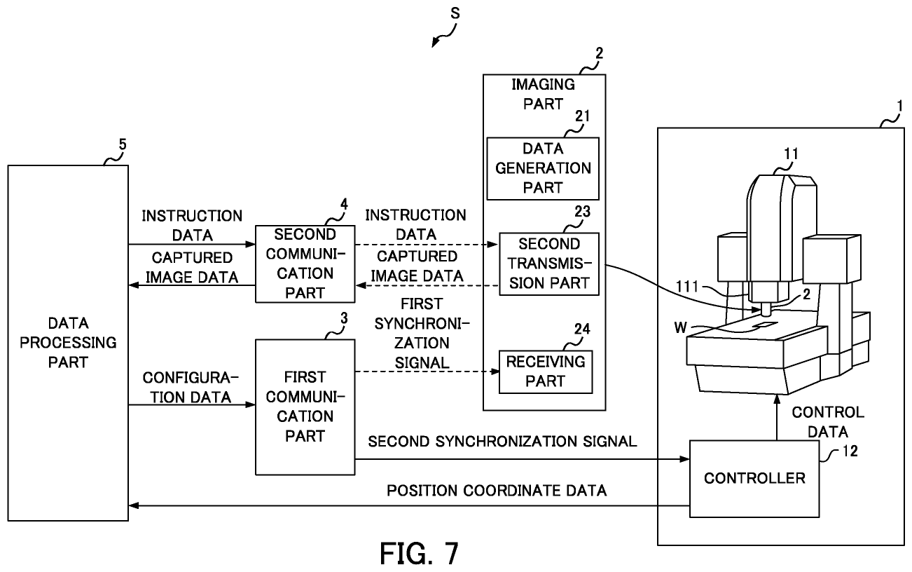

FIG. 7 is a diagram illustrating a configuration of a measurement system S according to a fourth modification. The imaging part 2 in the measurement system S illustrated in FIG. 7 includes a receiving part 24 instead of the first transmission part 22. The receiving part 24 receives the first synchronization signal from the first communication part 3. The data generation part 21 generates captured image data by capturing an image of the workpiece W at the basic capture timing determined on the basis of the first synchronization signal received by the receiving part 24. For example, the data generation part 21 generates captured image data by capturing an image of the workpiece W at the basic capture timing delayed from the first synchronization signal by a delay time of the second synchronization signal relative to the first synchronization signal.

When the measurement system S includes a plurality of imaging parts 2, the first communication part 3 may transmit the first synchronization signal to the plurality of imaging parts 2. In this case, all or some of the imaging parts 2 among the plurality of imaging parts 2 generate the captured image data at the basic capture timing based on the first synchronization signal. With this configuration of the measurement system S, the plurality of imaging parts 2 can easily operate in synchronization with each other, and the plurality of imaging parts 2 can simultaneously capture the workpiece W from different directions, whereby the measurement time can be shortened and the measurement accuracy can be improved.

### Overview of the Measurement System S

In a case where a shape of a workpiece is measured using captured image data generated by capturing an image of a measurement target object while changing a position of a mounting portion, included in a machine apparatus such as a machine tool or a coordinate measuring machine, in a state where a sensor is mounted on the mounting portion, a data processing device that processes measurement data such as the captured image data needs to analyze data indicating a position of the sensor in association with the captured image data. When the sensor is not connected to the main body of the machine apparatus by a cable, the captured image data needs to be transmitted to the data processing device via a wireless channel.

However, because a transmission delay occurs in the wireless channel, the position of the mounting portion when the captured image data arrives at the data processing apparatus differs from the position of the mounting portion when the captured image data is generated. Therefore, it is difficult to associate the captured image data with the position of the sensor when the captured image data is generated, and there is a problem in that the measurement accuracy decreases.

To address such a problem, while being mounted on the mounting portion 111, the imaging part 2 in the measurement system S generates captured image data by capturing an image of the workpiece W at the basic capture timing synchronized with the first synchronization signal, transmits the first synchronization signal on the first wireless channel, and transmits the captured image data on the second wireless channel different from the first wireless channel. Then, the first communication part 3 receives the first synchronization signal from the imaging part 2 via the first wireless channel, and transmits the second synchronization signal to the machine apparatus 1 on the basis of the first synchronization signal. Accordingly, even when the imaging part 2 is detachably mounted on the mounting portion 111 and the captured image data is transmitted via the wireless channel, it is possible to improve the accuracy of measuring the measurement target object.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

With respect to the embodiments including the above examples, the following appended notes are further disclosed.

### Appended Note 1

A measurement system for measuring a workpiece mounted on a machine apparatus having a function of controlling a position of a mounting portion to which a device for processing or measuring the workpiece is detachably mounted, the measurement system including: an imaging part configured to, while being mounted on the mounting portion, generate captured image data by capturing an image of the workpiece at a basic capture timing synchronized with a first synchronization signal, transmit the first synchronization signal on a first wireless channel, and transmit the captured image data on a second wireless channel different from the first wireless channel; a communication part that receives the first synchronization signal from the imaging part via the first wireless channel and transmits a second synchronization signal to the machine apparatus on the basis of the first synchronization signal; and a data processing part that associates position coordinate data indicating a position of the imaging part with the captured image data generated at the basic capture timing, the position coordinate data being output from the machine apparatus that has received the second synchronization signal.

### Appended Note 2

The measurement system according to claim 1, wherein the data processing part associates each of a plurality of pieces of the captured image data acquired after transmitting an instruction to the imaging part to start capturing the workpiece with the position coordinate data acquired in the same order as the order in which the pieces of captured image data are acquired.

### Appended Note 3

The measurement system according to claim 1 or 2, wherein the data processing part associates the position coordinate data acquired within a predetermined time range with the captured image data, after transmitting an instruction to the imaging part to start capturing the workpiece.

### Appended Note 4

The measurement system according to any one of claims 1 to 3, wherein the basic capture timing is a timing delayed from a timing at which the first synchronization signal is generated by a delay time from when the first synchronization signal is generated to when the communication part transmits the second synchronization signal or a delay time from when the first synchronization signal is generated to when the data processing part receives the position coordinate data.

### Appended Note 5

The measurement system according to any one of claims 1 to 4, wherein the communication part generates the second synchronization signal after determining whether or not the first synchronization signal has been normally received.

### Appended Note 6

The measurement system according to claim 5, wherein the communication part generates the second synchronization signal corresponding to the first synchronization signal at a timing obtained by delaying the received first synchronization signal, on the basis of an offset time required for determining whether or not the first synchronization signal has been normally received.

### Appended Note 7

The measurement system according to claim 5, wherein the communication part predicts, on the basis of timings at which the first synchronization signal has been received in the past, a period during which the next first synchronization signal is likely to be received, and determines whether the first synchronization signal has been normally received within the predicted period.

### Appended Note 8

The measurement system according to claim 5, wherein the communication part generates the second synchronization signal at a timing at which a time corresponding to a period of the first synchronization signal has elapsed since the second synchronization signal was previously generated, when the communication part determines that the first synchronization signal has not been normally received.

### Appended Note 9

The measurement system according to any one of claims 1 to 8, wherein the imaging part generates the captured image data at one or more predetermined capture timings located between a plurality of the basic capture timings.

### Appended Note 10

The measurement system according to claim 9, wherein the data processing part estimates one or more coordinates of a position of the imaging part at the one or more capture timings located between a plurality of the basic capture timings, on the basis of a plurality of coordinates indicated by a plurality of pieces of the position coordinate data corresponding to a plurality of the basic capture timings, and associates the one or more coordinates with one or more pieces of the captured image data corresponding to the one or more capture timings.

### Appended Note 11

A measurement system for measuring a workpiece mounted on a machine apparatus having a function of controlling a position of a mounting portion to which a device for processing or measuring the workpiece is detachably mounted, the measurement system including: an imaging part configured to, while being mounted on the mounting portion, generate captured image data by capturing an image of the workpiece at a basic capture timing synchronized with a first synchronization signal, transmit the first synchronization signal on a first wireless channel, and transmit the captured image data on a second wireless channel different from the first wireless channel; a communication part that generates the first synchronization signal, transmits the first synchronization signal to the imaging part via the first wireless channel, and transmits a second synchronization signal to the machine apparatus on the basis of the first synchronization signal; and a data processing part that associates position coordinate data indicating a position of the imaging part with the captured image data generated at the basic capture timing, the position coordinate data being output from the machine apparatus that has received the second synchronization signal.

### Appended Note 12

An imaging apparatus mounted on a machine apparatus having a function of controlling a position of a mounting portion to which a device for processing or measuring a workpiece is detachably mounted, the imaging apparatus including: a data generation part configured to, while being mounted on the mounting portion, generate captured image data by capturing an image of the workpiece at a basic capture timing synchronized with a first synchronization signal; and an image data transmission part that transmits the first synchronization signal used by the machine apparatus to output position coordinate data indicating a position of the mounting portion on a first wireless channel and transmits the captured image data on a second wireless channel different from the first wireless channel.

### Appended Note 13

The imaging apparatus according to claim 12, further including: a synchronization signal transmission part that generates the first synchronization signal on the basis of a reference signal and transmits the generated first synchronization signal, wherein the data generation part sets, as the basic capture timing, a timing delayed from the reference signal by a predetermined time such that the basic capture timing coincides with a timing at which the machine apparatus outputs the position coordinate data.

### Appended Note 14

A measurement apparatus having a function of controlling a position of a mounting portion to which a device for measuring a workpiece is detachably mounted, the measurement apparatus including: a position control part that controls the position of the mounting portion; an imaging part configured to, while being mounted on the mounting portion, generate captured image data by capturing an image of the workpiece at a basic capture timing synchronized with a first synchronization signal, transmit the first synchronization signal on a first wireless channel, and transmit the captured image data on a second wireless channel different from the first wireless channel; a communication part that receives the first synchronization signal from the imaging part via the first wireless channel and transmits a second synchronization signal to the position control part on the basis of the first synchronization signal; and a data processing part that associates position coordinate data indicating a position of the imaging part with the captured image data generated at the basic capture timing, the position coordinate data being output from the position control part that has received the second synchronization signal.

### Appended Note 15

A measurement method executed by a computer for measuring a workpiece mounted on a machine apparatus having a function of controlling a position of a mounting portion to which a device for processing or measuring the workpiece is detachably mounted, the measurement method including: causing an imaging part to generate captured image data in a state in which the imaging part that captures an image of the workpiece at a basic capture timing synchronized with a first synchronization signal, transmits the first synchronization signal on a first wireless channel, and transmits the captured image data on a second wireless channel different from the first wireless channel is mounted on the mounting portion; causing a first communication device to receive the first synchronization signal from the imaging part via the first wireless channel, and causing the first communication device to transmit a second synchronization signal to the machine apparatus on the basis of the first synchronization signal; receiving the captured image data from a second communication device that receives the captured image data from the imaging part via the second wireless channel; and associating position coordinate data indicating a position of the imaging part with the captured image data generated at the basic capture timing, the position coordinate data being output from the machine apparatus that has received the second synchronization signal.

What is claimed is:

1. A measurement system for measuring a workpiece mounted on a machine apparatus having a function of controlling a position of a mounting portion to which a device for processing or measuring the workpiece is detachably mounted, the measuring system comprising:
an imaging part configured to, while being mounted on the mounting portion, generate captured image data by capturing an image of the workpiece at a basic capture timing synchronized with a first synchronization signal, transmit the first synchronization signal on a first wireless channel, and transmit the captured image data on a second wireless channel different from the first wireless channel;
a communication part that receives the first synchronization signal from the imaging part via the first wireless channel and transmits a second synchronization signal to the machine apparatus on the basis of the first synchronization signal; and
a data processing part that associates position coordinate data indicating a position of the imaging part with the captured image data generated at the basic capture timing, the position coordinate data being output from the machine apparatus that has received the second synchronization signal.

2. The measurement system according to claim 1, wherein the data processing part associates each of a plurality of pieces of the captured image data acquired after transmitting an instruction to the imaging part to start capturing the workpiece with the position coordinate data acquired in the same order as the order in which the pieces of captured image data are acquired.

3. The measurement system according to claim 1, wherein the data processing part associates the position coordinate data acquired within a predetermined time range with the captured image data, after transmitting an instruction to the imaging part to start capturing the workpiece.

4. The measurement system according to claim 1, wherein the basic capture timing is a timing delayed from a timing at which the first synchronization signal is generated by a delay time from when the first synchronization signal is generated to when the communication part transmits the second synchronization signal or a delay time from when the first synchronization signal is generated to when the data processing part receives the position coordinate data.

5. The measurement system according to claim 1, wherein the communication part generates the second synchronization signal after determining whether or not the first synchronization signal has been normally received.

6. The measurement system according to claim 5, wherein the communication part generates the second synchronization signal corresponding to the first synchronization signal at a timing obtained by delaying the received first synchronization signal, on the basis of an offset time required for determining whether or not the first synchronization signal has been normally received.

7. The measurement system according to claim 5, wherein the communication part predicts, on the basis of timings at which the first synchronization signal has been received in the past, a period during which a next first synchronization signal is likely to be received, and determines whether the first synchronization signal has been normally received in the predicted period.

8. The measurement system according to claim 5, wherein the communication part generates the second synchronization signal at a timing at which a time corresponding to a period of the first synchronization signal has elapsed since the second synchronization signal was previously generated, when the communication part determines that the first synchronization signal has not been normally received.

9. The measurement system according to claim 1, wherein the imaging part generates the captured image data at one or more predetermined capture timings located between a plurality of the basic capture timings.

10. The measurement system according to claim 9, wherein the data processing part estimates one or more coordinates of a position of the imaging part at the one or more capture timings located between a plurality of the basic capture timings, on the basis of a plurality of coordinates indicated by a plurality of pieces of the position coordinate data corresponding to a plurality of the basic capture timings, and associates the one or more coordinates with one or more pieces of the captured image data corresponding to the one or more capture timings.

11. A measurement system for measuring a workpiece mounted on a machine apparatus having a function of controlling a position of a mounting portion to which a device for processing or measuring the workpiece is detachably mounted, the measurement system comprising:
an imaging part configured to, while being mounted on the mounting portion, generate captured image data by capturing an image of the workpiece at a basic capture timing synchronized with a first synchronization signal, transmit the first synchronization signal on a first wireless channel, and transmit the captured image data on a second wireless channel different from the first wireless channel;
a communication part that generates the first synchronization signal, transmits the first synchronization signal to the imaging part via the first wireless channel, and transmits a second synchronization signal to the machine apparatus on the basis of the first synchronization signal; and
a data processing part that associates position coordinate data indicating a position of the imaging part with the captured image data generated at the basic capture timing, the position coordinate data being output from the machine apparatus that has received the second synchronization signal.

12. An imaging apparatus mounted on a machine apparatus having a function of controlling a position of a mounting portion to which a device for processing or measuring a workpiece is detachably mounted, the imaging apparatus comprising:
a data generation part configured to, while being mounted on the mounting portion, generate captured image data by capturing an image of the workpiece at a basic capture timing synchronized with a first synchronization signal; and
an image data transmission part that transmits the first synchronization signal used by the machine apparatus to output position coordinate data indicating a position of the mounting portion on a first wireless channel and transmits the captured image data on a second wireless channel different from the first wireless channel.

13. The imaging apparatus according to claim 12, further comprising:
a synchronization signal transmission part that generates the first synchronization signal on the basis of a reference signal and transmits the generated first synchronization signal, wherein
the data generation part sets, as the basic capture timing, a timing delayed from the reference signal by a predetermined time such that the basic capture timing coincides with a timing at which the machine apparatus outputs the position coordinate data.

14. A measurement apparatus having a function of controlling a position of a mounting portion to which a device for measuring a workpiece is detachably mounted, the measurement apparatus comprising:
a position control part that controls the position of the mounting portion;
an imaging part configured to, while being mounted on the mounting portion, generate captured image data by capturing an image of the workpiece at a basic capture timing synchronized with a first synchronization signal, transmit the first synchronization signal on a first wireless channel, and transmit the captured image data on a second wireless channel different from the first wireless channel;
a communication part that receives the first synchronization signal from the imaging part via the first wireless channel and transmits a second synchronization signal to the position control part on the basis of the first synchronization signal; and
a data processing part that associates position coordinate data indicating a position of the imaging part with the captured image data generated at the basic capture timing, the position coordinate data being output from the position control part that has received the second synchronization signal.

15. A measurement method executed by a computer for measuring a workpiece mounted on a machine apparatus having a function of controlling a position of a mounting portion to which a device for processing or measuring the workpiece is detachably mounted, the measurement method comprising:
causing an imaging part to generate captured image data in a state in which the imaging part that captures an image of the workpiece at a basic capture timing synchronized with a first synchronization signal, transmits the first synchronization signal on a first wireless channel, and transmits the captured image data on a second wireless channel different from the first wireless channel is mounted on the mounting portion;
causing a first communication device to receive the first synchronization signal from the imaging part via the first wireless channel, and causing the first communication device to transmit a second synchronization signal to the machine apparatus on the basis of the first synchronization signal;
receiving the captured image data from a second communication device that receives the captured image data from the imaging part via the second wireless channel; and
associating position coordinate data indicating a position of the imaging part with the captured image data generated at the basic capture timing, the position coordinate data being output from the machine apparatus that has received the second synchronization signal.
